(19) United States
(12) Patent Application Publication
(10) Pub. No.: US 2017/0280511 A1
(43) Pub. Date: Sep. 28, 2017

(54) Faraday Effect Circulating Heat System and Method

(71) Applicant: Thomas E. Fiducci, Chicago, IL (US)

(72) Inventor: Thomas E. Fiducci, Chicago, IL (US)

(21) Appl. No.: 15/283,841

(22) Filed: Oct. 3, 2016

Related U.S. Application Data
(63) Continuation-in-part of application No. 15/077,440, filed on Mar. 22, 2016.

(51) Int. Cl. H05B 6/10

(52) U.S. Cl. CPC H05B 6/108; H05B 6/109; H01F 7/0205

(57) ABSTRACT

A Faraday heating system that can be used to heat and circulate a working fluid through a space for heating. Several permanent magnets are mounted on a non-magnetic disk. The magnets are mounted with the north and south poles alternating. A highly conductive metal tube is mounted in proximity to the magnets so that when the disk is rotated, the magnetic field lines cut the tube inducing eddy currents in the tube. This causes the tube to heat. Liquid is pumped through the tube and is heated. The heat transfer can be controlled by changing the speed of rotation of the disk. A ferrous metal member can be placed in proximity to the conductive metal tube to concentrate magnetic flux in the tube enhancing the heating effect.

This is a continuation-in-part of application Ser. No. 15/077,440 filed Mar. 22, 2016. Application Ser. No. 15/077,440 is hereby incorporated by reference.

### BACKGROUND

Field of the Invention

The present invention relates generally to space heating systems and more particularly to a Faraday effect circulating hot liquid building heating system and method.

Description of the Prior Art

Circulating hot water heating systems are well known in the art of building heating. Typically a furnace or boiler is used to produce either hot water or steam which is then circulated throughout a series of pipes as either steam or more likely hot water through a series of radiators to heat spaces. The drawback to such systems is that the furnace or boiler is either on or off. There is not control of the amount of heat being produced. For example, Vandenberg in U.S. Pat. No. 2,748,710 teaches a heat circulating pump system. Marshall in U.S. Pat. No. 3,213,929 teaches a temperature control system for a liquid circulating system.

Faraday induction heating is also well-known in the art. A time changing magnetic flux that induces an electric field around the perimeter of the flux. If a conductor is present on this perimeter, it sees a voltage which causes a current to flow in the conductor. If the resistive path of the conductor is low, it will heat. Induction heating is commonly used in industry.

It is also known that if permanent magnets are moved past a conductor, or vice-versa, they induce a Faraday voltage into the conductor. This is the principle of an electric generator. De Bennetot in U.S. Pat. No. 4,486,638 teaches using a wind turbine to turn a magnetic rotor near the conducting walls of a cavity to produce heat. Dooley in US Patent Publication 2004/0189108 moves windings near permanent magnets.

It would be extremely advantageous to have a system that used Faraday Effect heating by rotating magnets hear a conductive tube containing a fluid to be heated which is then pumped through a space or building for heating.

Therefore, it is an object of the present invention to provide a heat exchanger that can replace conventional gas type heaters, costs much less to operate and its green for the environment. The present invention can replace conventional boilers in closed loop radiator heating systems, radiant floor systems and baseboard heating systems or conventional forced air gas heating systems.

It is also an object of the present invention to provide a heating system for electric vehicles. Conventional automobiles receive their heat from the gasoline engine's radiator once the vehicle's engine gets hot. The present invention is advantageous for any electric vehicle since there is no gasoline engine to supply heat.

Finally, it is an object of the present invention to provide a heating device that can produce heat within seconds after it being turned on.

### SUMMARY OF THE INVENTION

The present invention relates to a Faraday heating system that can be used to heat and circulate water or other fluid through a building, home or space for heating. The present invention includes a new type of heat exchanger that uses only electricity to produce hot water, or other liquid, for heating homes, office buildings and even electric vehicles.

A series of permanent magnets are mounted around the periphery, or elsewhere, on a non-magnetic disk. Typically, the magnets are small cylinders with a north pole at one end of the cylinder and a south pole at the other end. The cylinder magnets are mounted with their poles facing outward from the flat surface of the disk. The magnets are mounted with the north and south poles alternating so that if a particular magnet presents a north pole, the next magnet presents a south pole and so forth. This causes a series of field lines to extend out from the disk from magnet to magnet. A copper or other highly conductive tube is mounted near the periphery of the disk so that when the disk is rotated, the magnetic field lines cut the tube inducing eddy currents in the tube. This causes the tube to heat. Circulating liquid is pumped through the tube, so that as the disk is rotated by a motor, the liquid heats in the tube. The amount of heat transfer can be controlled by changing the speed of rotation of the disk. The heated liquid can then be pumped, or otherwise circulated, through a standard liquid heating system. Information from one or more thermostats can be fed back to a motor controller to increase or decrease the speed of rotation of the disk as more or less heat is needed. Various configurations of both the magnets and the tubing in relation to the disk are possible in different embodiments of the present invention.

In an embodiment of the present invention, ferrous a ring or other shape of ferrous material such as soft iron is mounted in a position near the tube. This increases the magnetic effect and the heating. In an other embodiment of the present invention, an electric coil can be brought near the assembly, this causes the induction of an alternating current into the coil which can be used for lighting and other uses.

### DESCRIPTION OF THE FIGURES

Attention is now directed to several figures that illustrate features of the present invention:

FIG. 1A shows a top view of a non-magnetic disk with magnets mounted around the periphery.

FIG. 1B shows a side view of the disk of FIG. 1A.

FIG. 2A shows a particular configuration of metal tubing in relation to the disk and magnets.

FIG. 2B shows the metal tubing in proximity to both the top and bottom of the disk.

FIG. 2C shows two separate metal tubes, one in proximity to the top of the disk, the other in proximity to the bottom of the disk.

FIG. 2D shows a top view of a configuration where the tubing makes a loop in proximity to the top of the disk and then continues and makes a second loop in proximity to the bottom of the disk.

FIG. 3 shows a diagram of how heat is produced in the metal tubing using the Faraday Effect.

FIG. 4A shows a diagram of a circulating liquid heating system using an embodiment of the present invention.

FIG. 4B shows the system of FIG. 4A with no hot water reservoir.

FIG. 5A shows a square loop where there is only tight proximity at two locations.

FIG. 5B shows a disk with additional magnets mounted in concentric rings.

FIG. 5C shows a tubing configuration for use with the disk of FIG. 5B.

FIGS. 6A-6B show an alternate embodiment of the present invention in side and front views with a ring of ferrous material mounted near the conductive tube.

FIG. 7A shows the use of a small coil near the spinning magnets.

FIG. 7B shows the same coil as that of FIG. 7A, but with a ferrous core.

FIG. 8 shows different configurations for the ferrous metal member that concentrates flux in the conductive tube.

Several illustrations have been presented to aid in understanding the present invention. The scope of the present invention is not limited to what is shown in the figures.

### DESCRIPTION OF THE PREFERRED EMBODIMENTS

The present invention relates to a Faraday Effect heating system for spaces, buildings, homes and electric vehicles that uses only electricity to produce heat.

The main parts used in the present invention are: a non-magnetic disk, a set of neodymium or other permanent magnets, copper tubing or other metal tubing, a first electric motor with optional speed control, and a pump generally operated by a second electric motor. The disk is mounted on bearings and connected to the first motor with a shaft. The first motor spins up the non-magnetic disk with the neodymium magnets mounted near or on the edge of the disk exposing both ends of each rod shaped neodymium magnet. The metal tubing can be shaped in the same pattern mounted in a stationary position around the locations of the mounted neodymium magnets top and bottom of the non-magnetic disk. When the disk starts to spin the tubing acts as a dead electrical short causing the copper tubing to become very hot from eddy currents induced by the Faraday Effect. The second motor is used in pumping cold water or other liquid through the hot metal tubing and the rest of the heating system. The speed of rotation, or RPM, of the non-magnetic disk with the magnets determines how hot the copper tubing becomes, or more exactly how much heat it can transfer to the liquid. The faster the disk spins near the stationary metal tubing, the more heat is transferred to the liquid causing the liquid temperature to increase. Changing the speed of the disk rotation regulates the output temperature of the liquid being circulated through the heated space. A thermostat can be used to feed back temperature information to a motor speed controller for closed-loop operation.

With conventional gas heaters there are only two modes of operation, full heat on and heat off. When the home of office calls for heat, the conventional gas heater turns on full heat until the desired temperature is reached and then turns off completely. Once the temperature goes below a set temperature, it then repeats the heat on and then off cycle. This causes the temperature in the heated space to increase to an upper set point when the furnace is on and fall to a lower set point when the furnace is off.

With the present invention, there is more then just full heat on and heat off. There can be a trickle heat mode that depends on the desired hold temperature. When the heated space calls for heat, the present invention typically turns on full heat output, but when the desired temperature is reached, the system can go into a trickle heat mode to keep the heated space at an even steady temperature. Since the amount of heat supplied to the circulating liquid is directly proportional to the speed of rotation of the disk, very fine temperature control of the liquid and the heated space can be achieved by simply changing the disk rotation speed.

This is much more efficient then a conventional gas heater. It is very similar to a flywheel principle. It takes a lot of energy to start spinning up a flywheel, but once it's spinning, it only takes a small amount of energy to keep it spinning. The present invention works in a similar way thus using less energy and keeping the heated space at a constant desired temperature. There is no variation between thermostat on and thermostat off, and no annoying change from the upper set point temperature to the lower set point temperature of a convention gas heater.

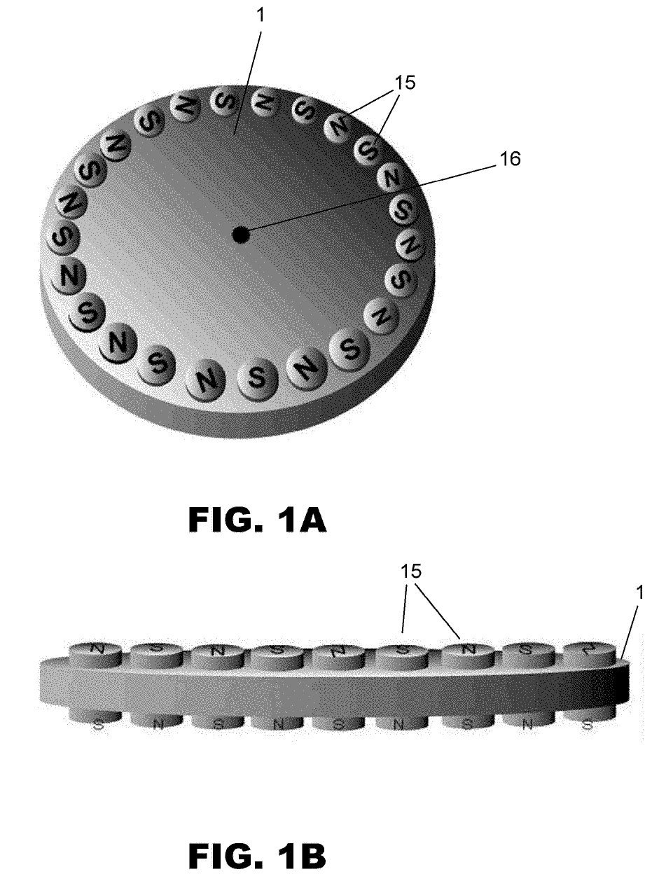

Turning to FIG. 1A, an embodiment of the non-magnetic disk with the magnets is seen. The disk 1 contains at least one ring of mounted permanent magnets 15 near its rim. The preferred material for the disk is aluminum; however, any non-ferrous magnetic material will work. The preferred magnets are neodymium cylinder magnets. The magnets 15 are mounted with north and south poles alternating around the disk as shown in FIG. 1A. The center 16 of the disk 1 is adapted to receive a shaft that can be mounted on bearings so that a motor can spin the disk up to a high angular velocity. FIG. 1B shows a side view of the disk of FIG. 1A. It can be seen that the magnets 15 present on both the top and bottom flat surfaces of the disk 1. The magnets can also optionally be mounted on the edge of the disk.

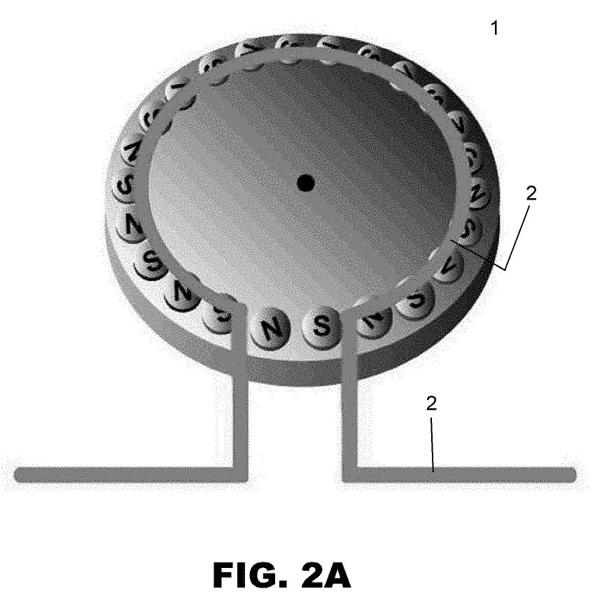

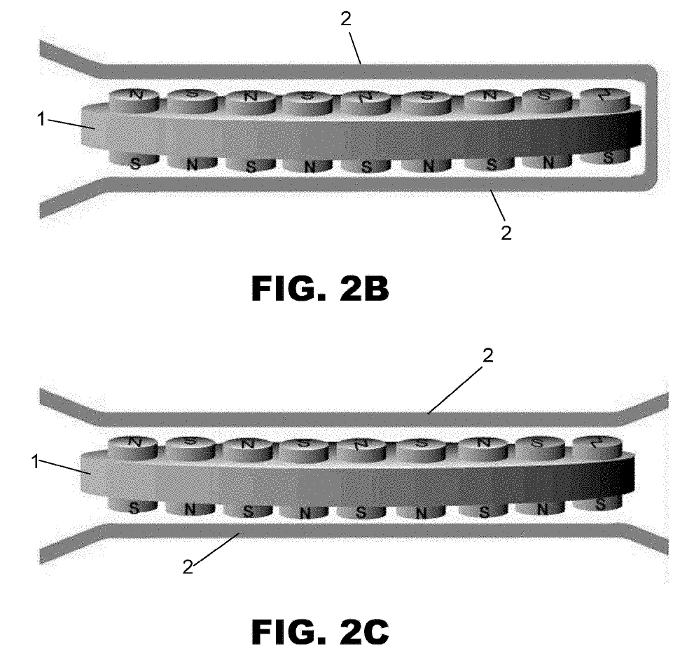

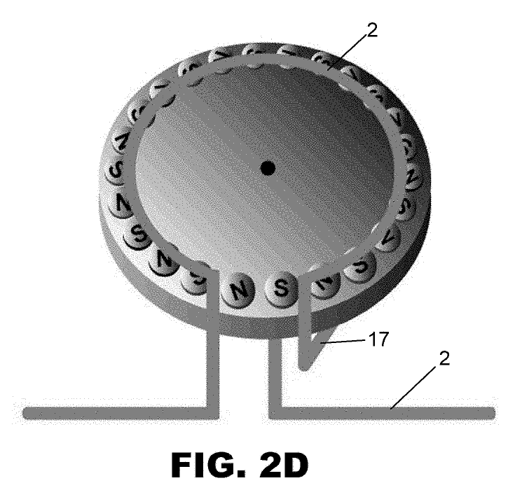

FIG. 2A shows the disk 1 of FIG. 1A with a section of metal tubing 2 in proximity to the ring of magnets 15. The preferred material for the tubing is copper; however, any highly electrical conductive material may be used. In FIG. 2A, the tubing 2 only rings one side of the disk 1. In other embodiments, the tubing can be placed in proximity to both the top and bottom magnet poles. For example, FIG. 2B shows the tubing 2 in proximity to both the top and bottom of the disk 1. FIG. 2C shows two separate pieces of tubing, one in proximity with the top of the disk and the other in proximity with the bottom of the disk. Any configuration or relationship of the tubing with respect to the magnets and the disk is within the scope of the present invention.

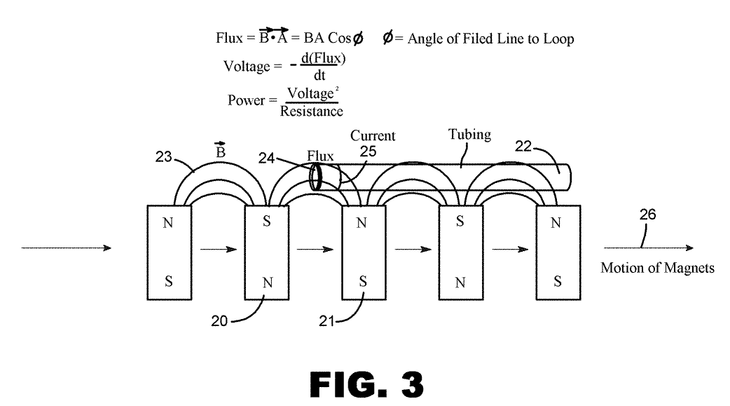

FIG. 3 shows details of how the heating of the tubing takes place. A row of permanent magnets is arranged adjacent to one-another (in a ring around the disk or otherwise). While cylindrical magnets are preferred, any cross-section of the magnets is within the scope of the present invention. The poles of the magnets alternate as shown in FIG. 3. For example, the poles of magnet 20 are opposite to the poles of magnet 21 and so forth around the disk. As the disk rotates, the magnets move in space. In FIG. 3, the magnets move from left to right 26. Metal tubing 2 is mounted in proximity to the magnet poles. In FIG. 3, only a portion of the tube is shown. As stated, the preferred tube is copper tubing. Other, optional configurations and arrangements of the magnets are within the scope of the present invention. The only requirement is that magnetic field lines create flux in the tubing.

The magnets produce magnetic B field lines 23 from N poles to S poles. The B field lines 23 cut across a roughly circular rings that span the parameter of the tubing causing these rings to see a magnetic flux across their surfaces. One such imaginary ring is shown in FIG. 3. The flux across the ring is defined as: Flux=BA Cos (phi) where B is the scalar magnetic field line strength, A is the area of the ring and phi is the angle between the field line and the plane of the surface of the ring. A static flux does not induce a voltage around the ring; however, a time changing flux does. As the magnets move past the tube (rings), the flux becomes a function of time. Faraday's Law states that the induced voltage (or EMF) around a ring defining a flux is EMF=−d(flux)/dt, or is proportional to the rate of change of the flux. The minus sign (called Lenz's Law) states that any current that flows as a result of this induced voltage creates a second magnetic field that opposes the original magnetic field. This conserves energy.

As the imaginary rings on the surface of the tubing move past the magnets, the induced EMF or voltage around each ring causes a current 25 to flow according to Ohm's Law. Current I=V/R. Since the resistance of the metal tube is low, a high current 25 develops. This current immediately causes the metal to heat by putting power into the metal according to P=I (squared) R (or alternatively P=V(squared)/R) The metal acts as basically a dead short and hence, gets very hot. If liquid is flowing through it, the generated heat in the metal can be continually transferred to the liquid. Due to Lenz's Law, the faster the disk is rotated, the harder it becomes to rotate it against the induced magnetic field. Again, this conserves energy by requiring the driving motor to draw more input current from the AC line, or other energy supply, to rotate the disk faster then to rotate it slower. The faster the disk rotates, the more heat it produces. The rate of heat transfer to the liquid, and hence its temperature rise, depends on its thermal capacity, its flow rate and whether the flow is laminar or turbulent. In any case, the liquid can be heated very efficiently.

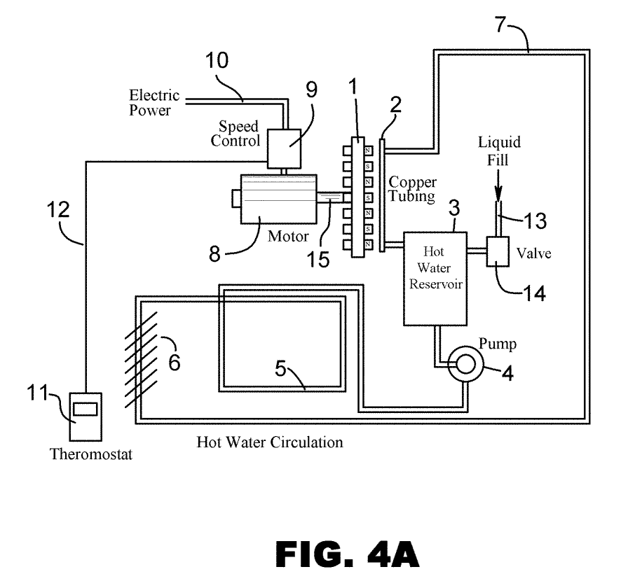

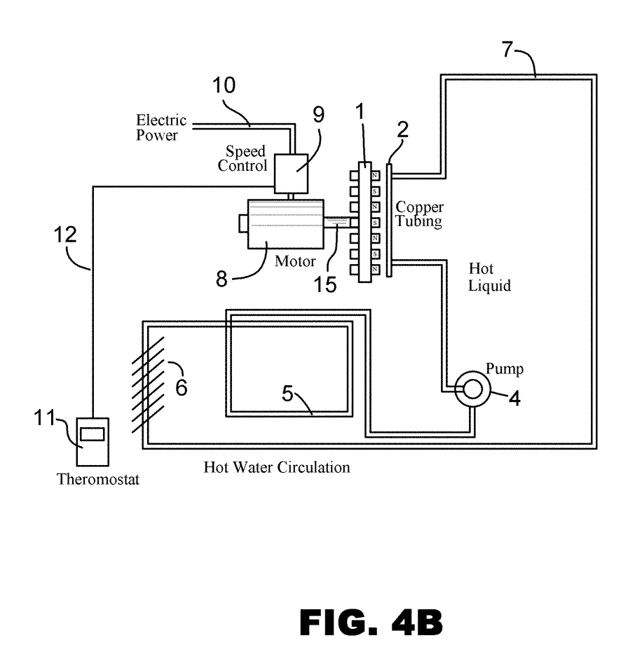

FIG. 4A shows a schematic of a complete closed-loop heating system. A disk 1 holding magnets 15 as previously described is mounted on bearings and driven by motor 8. The motor 8 can be an AC or DC motor. Any motor is within the scope of the present invention; however, a motor whose RPM can be controlled with a controller is preferred.

Water or other thermal fluid can be held in a reservoir 3 and is moved by a pump 4 through the heat exchange piping system 5. The heated liquid in the piping can heat room air through the use of radiators 6 known in the art. Cooled water from the heating system 5 is returned through piping 7 to the copper or other metal tube 2 that passes in proximity to the moving mounted magnets 15. The tubing near the magnets heats according to the Faraday Effect as previously described transferring heat to the fluid raising or maintaining its temperature to a desired value.

Source water or other fluid can be filled introduced through a cool liquid inlet 13 controlled by a valve 14. When the system is operated in closed loop (with the same liquid re-circulating continuously), new liquid only needs to be introduced to either initially fill the system, or to replace any lost in the process.

FIG. 4B shows the same system, but with no hot water reservoir.

In either the embodiment of FIG. 4A or 4B, one or more thermostats 11 in the heating space can report back to a controller 9 either via a cable 12 or wirelessly. The speed controller can increase or decrease the speed of rotation of the disk 1 as needed to supply more or less heat to the circulating fluid. Energy into the system is supplied by an electric power supply 10 which can be the AC power line or some other power supply such as the batteries of an electric vehicle or solar panels. As the disk rotates faster, more current must be supplied from the power supply 10 according to Lenz's Law.

While FIGS. 4A and 4B show a closed loop fluid re-circulator, it is also possible to operate the system open loop with a continuous supply of cold fluid entering the system at the cool liquid inlet 13 with used fluid being discarded after it is first heated and then passed through the space heating system 5. This is less convenient than a closed loop system in that spent water or fluid must be drained somewhere.

While a preferred mode of operation is to use a rotating disk, any configuration of moving magnets may be used including rows of magnets that move back and forth in linear motion. The only requirement is that the moving magnets create a time changing magnetic flux in the tube.

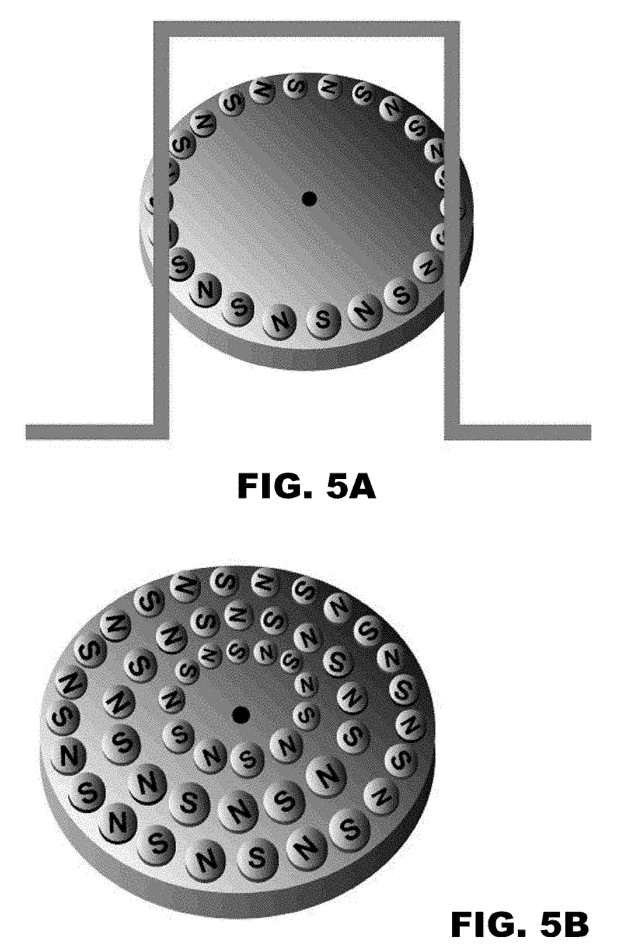

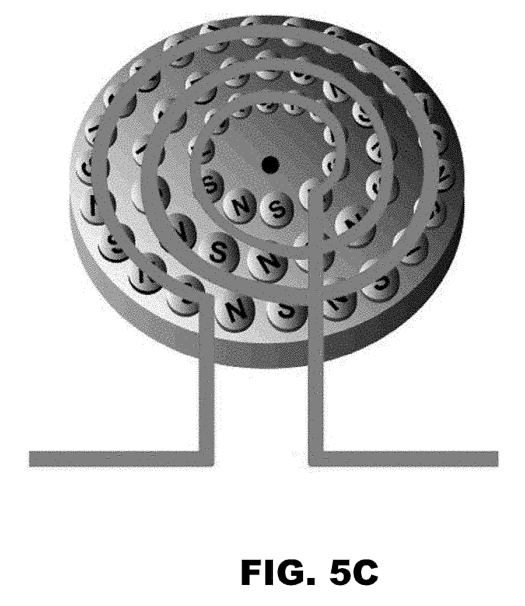

FIGS. 5A-5C show different embodiments of the present invention. FIG. 5A shows a configuration where a rectangular tube only encounters the magnets in two positions. This configuration might be used where there is not enough space to provide a greater proximity area. FIGS. 5B-5C show a disk with multiple magnet rings. The tubing in FIG. 5C spirals to make proximity to as many of the magnets as possible. This embodiment provides a very large proximity area. Because, the linear velocity is greater at the periphery of the disk as opposed to further toward the center, the outer portions of the tubing heat more than the inner portions since the individual magnets are passing the tube faster at the periphery causing a greater rate of change of flux in the tubing walls.

Any configuration of tubing and magnets is within the scope of the present invention.

The following are examples of embodiments of the present invention:

### Example 1

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing and turning the flow of electrons into heat where a transfer liquid is pumped through the copper tubing collecting the heated molecules and exchanging them with another radiator heating the molecules of air around the radiator.

### Example 2

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing and turning the electron flow into heat where a transfer liquid is pumped through the copper tubing collecting the heated molecules and exchanging them with another radiator heating the molecules of air around the radiator and where a fan is used to help disperse the heated air molecules.

### Example 3

A mechanical device consisting of a non-magnetic disk holding magnets in a north south configuration and copper tubing shaped in the same pattern mounted next to the magnets on the non-magnetic disk, where the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the speed of the spinning non-magnetic disk determines the temperature of the liquid pumped through the copper tubing.

### Example 4

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator wherein the space between the copper tubing being further away from the magnets will produce less heat.

### Example 5

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the cross-section of the copper tubing is rectangle.

### Example 6

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the cross-section of the copper tubing is flat rectangle.

### Example 7

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the cross-section of the copper tubing is round.

### Example 8

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in non-magnetic disk is stainless steal.

### Example 9

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the non-magnetic disk is aluminum.

### Example 10

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the disk is any non-magnetic material.

### Example 11

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the copper tubing has ridges inside the tubing wall.

### Example 12

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the copper tubing has more then one channel for liquid to flow through.

### Example 13

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the magnets are a solid mass magnetic material.

### Example 14

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the magnets are electro magnetic coils and ferro-magnetic material.

### Example 15

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the magnets are electromagnetic coils and magnetic materials and powering only some of the coils limiting the amount of heat output.

### Example 16

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the motor spinning the non-magnetic disk is a AC motor.

### Example 17

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the motor spinning the non-magnetic disk is a DC motor.

### Example 18

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the motor pumping the liquid through the copper tubing is a AC motor.

### Example 19

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the motor pumping the liquid through the copper tubing is a DC motor.

### Example 20

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the electric power source to run the motors can be a utility grid.

### Example 21

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the electric power source to run the motors can be solar cells.

### Example 22

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the electric power source to run the motors can be batteries.

### Example 23

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the magnets are only on one side of the non-magnetic disk.

### Example 24

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the magnets are on both sides of the non-magnetic disk.

### Example 25

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there is only one non-magnetic disk with magnets.

### Example 26

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there are two or more non-magnetic disk with magnets.

### Example 27

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there is only one non-magnetic disk with magnets and one stationary copper tubing.

### Example 28

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there is only one non-magnetic disk with magnets and two stationary copper tubing's one for the top side and one for the bottom side and the copper tubing's are connected to each other.

### Example 29

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there is only one non-magnetic disk with magnets and two stationary copper tubing's one for the top side and one for the bottom side and the copper tubing's are not connected to each other.

### Example 30

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there are two or more non-magnetic disk with magnets and two stationary copper tubing's for each non-magnetic disk one for the top side and one for the bottom side and the copper tubings are connected to each other in series.

### Example 31

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there are two or more non-magnetic disk with magnets and two stationary copper tubing's for each non-magnetic disk one for the top side and one for the bottom side and the copper tubings are connected to each other in parallel.

### Example 32

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in there are two or more non-magnetic disk with magnets and two stationary copper tubing's for each non-magnetic disk one for the top side and one for the bottom side and the copper tubing's are not connected to each other.

### Example 33

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the spinning non-magnetic disk can be clockwise or counter clockwise.

### Example 34

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in only one motor is required in spinning the non-magnetic disk and pumping the liquid through the tubing.

### Example 35

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in ones set of magnets are used on the top of the non-magnetic disk and a second set of magnets are used in the bottom of the non-magnetic disk.

### Example 36

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the volume of liquid running through the tubing will determine how hot the liquid will become.

### Example 37

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the there are rows of magnets and rows of tubing.

### Example 38

A mechanical device consisting of a non-magnetic disk holding magnets in a north south configuration and copper tubing shaped in the same pattern mounted next to the magnets on the non-magnetic disk, where in the disk is spinning and the copper tubing is stationary experiencing moving electrons from the magnets in the copper tubing turning the electron flow into heat where a transfer liquid is pumped through the copper tubing collecting heat and exchanging it with another radiator heating the molecules of air around the radiator where in the rows of magnets and rows of tubing are in a spiral configuration.

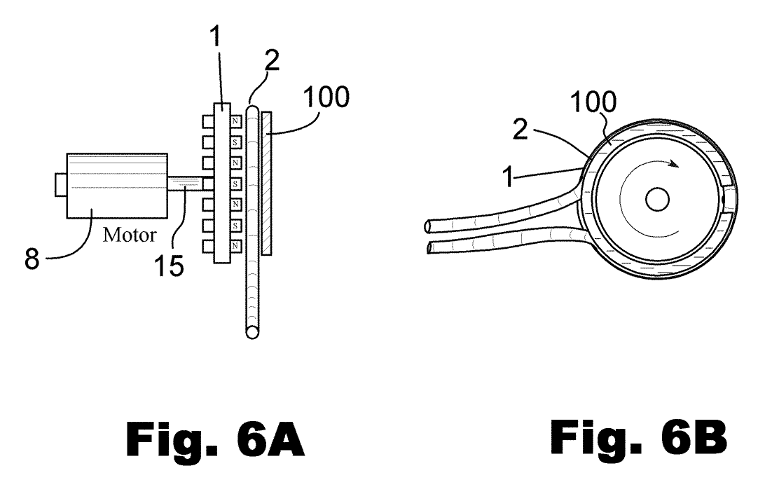

It has been determined experimentally that mounting a ferrous member of any shape near the conductive tubing channels the magnetic flux lines into the tubing enhancing the heating effect. The preferred ferrous material is soft iron; however, any ferrous material is within the scope of the present invention. FIGS. 6A-6B show an alternate embodiment of the present invention using this principle. FIG. 6A shows a side view, while FIG. 6B shows a front view. In this embodiment, a ring of ferrous material 100 is mounted near the conductive tube 2 that carries the working fluid. The preferred material for the ring is soft iron, and the preferred material for the tube is copper. This ring enhances the heating effect by concentrating the magnetic flux lines in and around the conductive tube. The ring 100 (or other shape) should be placed as close to the conductive tube as possible, preferably in contact with it. While FIGS. 6A-6B show the ring 100 being split (open at one end), this is not necessary. A continuous metal ring works just as well. Also, the ferrous material near the tube does not have to be continuous. Metal bolts, shafts or other shapes near the tube all serve to enhance the magnetic heating effect. It is ideal to cover tube's back and sides with the ferrous material as much as possible. The region of the conductive tube facing the magnets should not have a ferrous covering. Rather, the copper or other conductive metal should be placed as close to the magnets as the geometry will allow to allow maximum magnetic flux to enter the conductive tube. Also, the centers of the magnets should be aligned with the centerline of the tube if possible, since the fields around small permanent magnets is greatest on the centerline of the magnet.

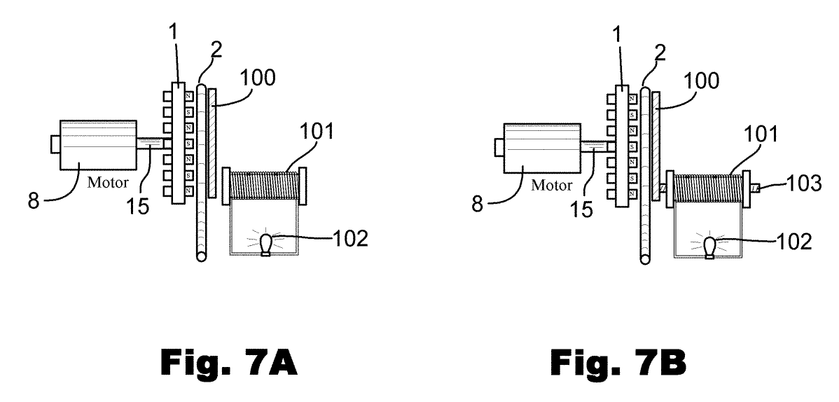

FIG. 7A shows another embodiment of the present invention. Here, a cylindrical coil of wire 102 on a spool has been placed near rotating magnet disk 1. In this case, the system is acting like a transformer inducing alternating current into the coil 101. Induced current from the coil can be used to light lights 102 or for other purposes. Energy must be conserved, so drawing current from the coil to a load increases the backward force on the rotating magnet disk 1. If the coil 101 is open, an induced voltage appears across it according to Faraday's Law and the laws of transformers.

FIG. 7B shows the embodiment of FIG. 7A with a ferrous core 103 in the coil 102. In this case, the core 103 is continuous with the ferrous ring 100. This is desirable, but not necessary. In fact, the system works well for lighting and the like even when no ferrous ring 100 is present, and when no central core 103 is present. So, while the ferrous ring 100 is shown in FIGS. 7A-7B, it can be totally removed with a reduction in heating effect.

In summary, placing any ferrous member such as soft iron on the opposite side of the conductive tubing (or on the top or bottom) concentrates magnetic flux into the metal of the tubing and causes more current to flow in the metal enhancing the heating effect. Placing a coil of wire near the conductive tubing causes an induced voltage in the coil of wire. The optimum orientation for the coil is as shown in FIGS. 7A-7B, namely with the winds aligned with the single wind that is the conductive tube.

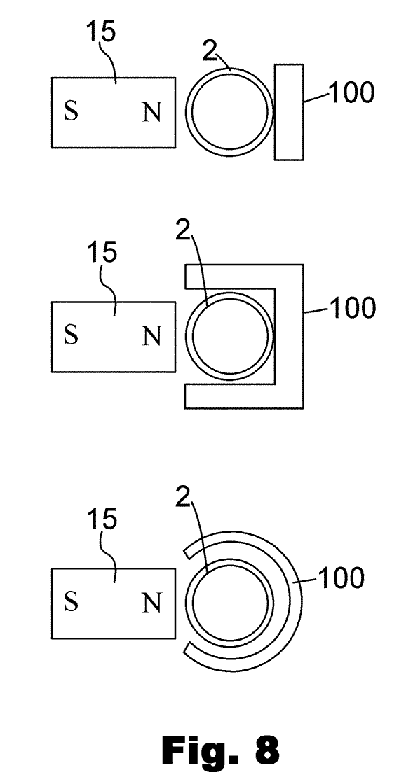

FIG. 8 shows different configuration for the ferrous member near or around the conductive metal tube. While these configurations are preferred, any other configuration is possible.

The present invention is highly desirable for electric vehicles. The spinning magnetic disk can be coupled into the drive train of the vehicle and be used to heat a working fluid such as water to provide heat for the vehicle in cold weather (and heat for the batteries) without having to use current from the batteries to drive inefficient heater elements. A small coil placed near the spinning magnet disk can provide enough current for interior vehicle lighting and other uses.

While several configurations and arrangements have been shown, numerous other configurations of the magnets and tubing are possible. Any such configuration is within the scope of the present invention. In particular, the magnets can be mounted on the edge of the disk facing outward. Also, numerous different configurations of the heating system and working fluid are possible, all of which are within the scope of the present invention. Conductive tube means an electrically conductive tube. Finally, one with skill in the art will realize that numerous other changes and variations are possible without departing from the spirit of the invention. Each of these changes and variations is within the scope of the present invention.

I claim:

1. A device for heating comprising:
a non-magnetic disk holding a plurality of magnets mounted in alternating north-south configuration around its periphery;
a electrically conductive tube in proximity to said magnets, the tube having a back side and front side; the electrically conductive tube constructed to receive a working fluid pumped through it;
a motor with a shaft attached to said non-magnetic disk configured to rotate said disk;
a ferrous metal member in proximity to the back side of the electrically conductive tube;
wherein, when said motor rotates the disk, the conductive tube heats due to Faraday Effect transferring heat to the working fluid thereby raising its temperature.

2. The device of claim 1 wherein the working fluid is water.

3. The device of claim 1 wherein the electrically conductive tube is copper.

4. The device of claim 1 wherein the electrically conductive tube forms a partial circle in proximity to the magnets on the periphery of the disk.

5. The device of claim 4 wherein the ferrous member is a flat ring or partial ring in proximity to the backside of the electrically conductive tube.

6. The device of claim 1 wherein the ferrous member is in proximity to the back, top and bottom of the electrically conductive tube.

7. The device of claim 1 wherein the motor is a variable speed motor.

8. The device of claim 1 wherein the ferrous member is soft iron.

9. The device of claim 1 further comprising a coil placed in proximity to said disk, wherein a voltage is induced into the coil when the disk is rotated.

10. A device for heating comprising:
a rigid frame holding a plurality of magnets mounted in alternating north-south configuration on at least one of its surfaces;
a metal tube in proximity to said magnets;
a ferrous metal member in proximity to the metal tube, configured to concentrate magnetic flux in the metal tube;
a motor configured to move the magnets with respect to the metal tube, causing the metal tube to heat.

11. The device of claim 10 further comprising a pump constructed to pump a liquid through the metal tube.

12. The device of claim 11 wherein said liquid is water.

13. The device of claim 10 wherein the metal tube is copper.

14. The device of claim 10 wherein the ferrous metal member is soft iron.

15. The device of claim 10 wherein the rigid frame is a non-magnetic disk, the metal tube forms a partial circle in proximity to the magnets on the non-magnetic disk, and the ferrous member is a flat ring or flat partial ring.

16. A method of heating a space comprising:
attaching a plurality of permanent magnets to at least one surface of a disk;
placing a metal tube in proximity to said magnets;
placing a ferrous metal member in proximity to the metal tube configured to concentrate magnetic flux in the metal tube;
rotating the disk;
pumping a working fluid through the metal tube causing the working fluid to become heated.

17. The method of claim 16 wherein the working fluid is water.

18. The method of claim 16 wherein the metal tube is copper tubing.

19. The method of claim 16 wherein the ferrous metal member is soft iron.

20. The method of claim 16 wherein the disk is rotated by a variable speed motor.
